(19) United States
(12) Patent Application Publication
(10) Pub. No.: US 2007/0273635 A1
(43) Pub. Date: Nov. 29, 2007

(54) Circuit Arrangement for Driving Arrangement

(76) Inventors: Antonius Petrus Gerardus Welbers, Walde (CH); Corneliu Tobescu, Zurich (CH); Francesco Maone, Zurich (CH)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 10/579,638

(22) PCT Filed: Nov. 10, 2004
(86) PCT No.: PCT/IB04/52368

§ 371 Date: Mar. 13, 2007

(30) Foreign Application Priority Data
Nov. 19, 2003 (EP) 03104275.7

(51) Int. Cl. G09G 3/36

(52) U.S. Cl. 345/100; 345/103; 349/37

(57) ABSTRACT

The invention concerns a circuit arrangement (2) for driving a display arrangement (1). Further it concerns a display arrangement (1) and a method for driving a display arrangement (1). To provide an arrangement (2) having a good offset cancellation combined with high quality illustrating of an image the circuit arrangement includes column driving means (5) for driving n column electrodes (C) and row driving means (4) for driving m row electrodes (R) of the display arrangement (1), wherein the column driving means (5) comprises n output channels (O), each output channel (O) having a column electrode (C) assigned and is arranged for providing a respective column voltage to the assigned column electrode (C), an additional output channel (O_{R}) is arranged for providing a respective column voltage, whereas each of the n column electrodes (C) is connectable to the additional output channel (O_{R}). The additional output channel (O_{R}) will be calibrated at first. Then the additional output channel will successively replace the output channel (O₁-Oₙ) whereas during replacement the output channels (O₁-Oₙ) will be calibrated sequentially. So the time required for offset cancellation will not reduce the time for settling the column voltage.

The invention concerns a circuit arrangement for driving a display arrangement. Further it concerns a display arrangement and a method for driving a display arrangement.

The display technique will play an increasingly important role in the information and communication technique in the years to come. Being an interface between humans and the digital world, the display device is of crucial importance for the acceptance of contemporary information systems. Notably portable apparatus such as, for example, notebooks, telephones, digital cameras and personal digital assistants cannot be realized without utilizing displays.

In general a liquid crystal display consists of a number of substrates. The display is subdivided in the form of a matrix of rows and columns. The row electrodes and column electrodes are arranged on respective substrates and form a grid. A layer with liquid crystals is provided between said substrates. The intersections of these electrodes form pixels. These electrodes are supplied with voltages that orient the liquid crystal molecules of the driven pixels in an appropriate direction so that the driven pixel appears in a different brightness.

There are two kinds of LC display arrangements—the passive matrix displays and the active matrix displays. The passive matrix LCD technology is a very commonly used display technology; it is used, for example in PDA's and in mobile telephones. Passive matrix displays are usually based on the (S)TN (Super Twisted Nematic) effect.

The active matrix displays also called TFT displays using a switching element within each pixel, which is commonly realized as a thin film transistor.

There are other kinds of display technologies, e.g. OLED, PLED or LTPS also having rows and columns arranged in matrix form.

In all kinds of display arrangements the image data to be displayed will be provided via the column electrodes. These column electrodes are driven by a column driver, which converts the image data supplied from a memory or an external device into the respective column voltage, which are necessary to drive the certain pixels of a selected row. The column driver means comprises a converting unit e.g. a digital analog converter, which converts the image data provided from the memory into analog signals. The column electrodes are driven by output channels. An output channel includes in particularly an amplifier or output buffer for amplifying the analog low level image signal to the respective column voltage level. Further a selection matrix is arranged for providing all possible column voltages to the output channel, wherein the respective column voltage is chosen via the selecting matrix.

For displaying a clear, high quality image it is very important to drive the column electrodes with well calibrated output channels without any offsets. Therefore each column output channel of the column driving means has to be calibrated before settling the required column voltage in dependency on the pixel value or image data to be displayed. The output channels normally having a mismatch between an input stage of the output buffers or a mismatch between the resistive elements in the DA-Converter. Further the offsets will be affected by process variations during manufacturing of the driver circuit.

A further problem for the calibration of the column output channels is that the time available for the calibration should be as short as possible, because the time is needed for settling respective column voltage output signal. Besides this the sampling of the column voltage is performed few microseconds before the load pulse (LD) to improve the cleanness of the column output signal, because of the data changing. Considering this situation leaves only 4-6 μs for offset cancellation. If this offset cancellation is not performed properly a degradation of the illustrated image is the result, because a difference of more then 7 mV in the column voltage is visible.

So the object of the present invention is to provide an arrangement having a good offset cancellation combined with high quality illustrating of an image. In particularly the time required for settling the column voltage should be as long as possible, without being reduced by the time required for offset cancellation.

To solve this object a circuit arrangement is provided for driving a display arrangement, the circuit arrangement includes column driving means for driving n column electrodes and row driving means for driving m row electrodes, wherein the column driving means comprises n output channels, each output channel having a column electrode assigned and is arranged for providing a respective column voltage to the assigned column electrode. Further an additional output channel is arranged for providing a respective column voltage, whereas each of the n column electrodes is connectable to the additional output channel.

The invention is based on the idea, that the time for offset cancellation for each output channel before loading the respective column voltage is too short and an offset cancellation within that short time will degrade the image quality. Therefore the additional output channel will be provided within the column driving means. This allows calibrating at first the additional output channel, whereby all other output channels could then be successively replaced by this calibrated additional output channel, whereas at the time the output channel is replaced by the additional output channel the normal output-channel will be calibrated. Thus all output channels will be calibrated sequentially, without reducing the time for settling the column voltage. The time for calibrating is long enough, because the switching between the output channels and the additional output channel will be performed with the row selecting procedure of the row electrodes.

During the first row selection time the additional channel is calibrated. Then the column 1 is connected with the calibrated additional channel. Then the next row is driven, whereas during that time the disconnected first column output channel is calibrated. So the first column is driven with a calibrated additional channel. Before driving the third row the additional channel is connected to the next column output channel (column 2) and the first column output channel is connected to the first column electrode again, because it is calibrated now. During driving the third row the second column electrode will be driven via the calibrated additional channel, whereas the first column is driven by its own calibrated first column output channel, whereas the second column output channel is just calibrated. This procedure will go on, until all column output channels are calibrated. Thus the time for calibrating an output channel is much longer than before. In particularly the time for offset cancellation is as long as a row is driven.

Since normally a display arrangement will have more columns than rows, more than one frame will be required until all output channels will be calibrated. The frame rate can be in the range of 60-85 Hz. However in view of the advantages this is an acceptable time. When the number of rows is greater or equal than the number of output channels divided by the number of additional output channels the calibration procedure will be completed within one frame.

The use of the additional output channel does not require more output channels to be designed, because the additional output channel is a not actively used output channel of the column driver, which is arranged within each column driving means, so called dummy output channels, which are used normally to maintain the matching between the output channels.

In a preferred embodiment of the invention switching means are arranged between an output channel and its associated column electrode for connecting the column electrode with the additional output channel. These switching means are provided for disconnecting the output channels from the column electrodes, if the column electrode is connected to the additional output channel. The controlling of the switches is done by a logic circuitry, which does not need much chip area and could be implemented into the normal logic circuitry within the driving means.

In a further preferred embodiment of the invention the additional output channel is calibrated at the beginning of driving a first row electrode of a frame, whereas during driving the following row electrodes the additional output channel is successively connected via the respective switching means to the remaining not calibrated column electrodes, whereas the associated output channel of the column electrode currently connected to the additional output channel is disconnected from the respective column electrode for calibrating.

In a further preferred embodiment of the invention the column driving means comprises more then one additional output channel which are connectable to the column electrodes. This will reduce the time for calibrating all output channels, because during one row selection time two output channels could be calibrated.

For calibrating the additional output channel and the output channels calibration means are arranged in particular for performing the offset cancellation of the output channels connected to the calibration means.

The object is also solved by a display device comprising a display arrangement and a display driver circuit arrangement, the display driver circuit arrangement comprises column driving means for driving the n column electrodes with column voltages and row driving means for driving the m row electrodes with row selection voltages, wherein the column driving means comprises n output channels, each output channel having a column electrode assigned and is arranged for providing a respective column voltage to the assigned column electrode, an additional output channel is arranged for providing column voltages, whereas each of the n column electrodes is connectable to the additional output channel.

The object is further solved by a method for driving a display arrangement, whereas the display arrangement comprises n column electrodes and m row electrodes, the n column electrodes are driven by column driving means and the row electrodes are driven by row driving means, wherein the column driving means comprises n output channels each providing a respective column voltage to its associated column electrode, wherein an additional output channel is arranged which is calibrated at the beginning of a driving procedure of a frame, wherein after the additional output channel is calibrated, one of the n output channels is disconnected from its associated column electrode, wherein this column electrode is connected to the calibrated additional output channel, the calibrated additional output channel supplies the respective column voltage to the column electrode, whereas the disconnected output channel is calibrated.

Depending on the used calibration scheme the inventive calibration procedure has to be done several times.

The inventive circuit arrangement is also applicable for other display solutions like OLED (Organic Light Emitting Diode) or PLED (Polymer Light Emitting Diode) or LTPS (Low Temperature Poly Silicon).

For a more complete description of the present invention and for further objects and advantages thereof, reference is made to the following description, taken in conjunction with the accompanying drawings, in which:

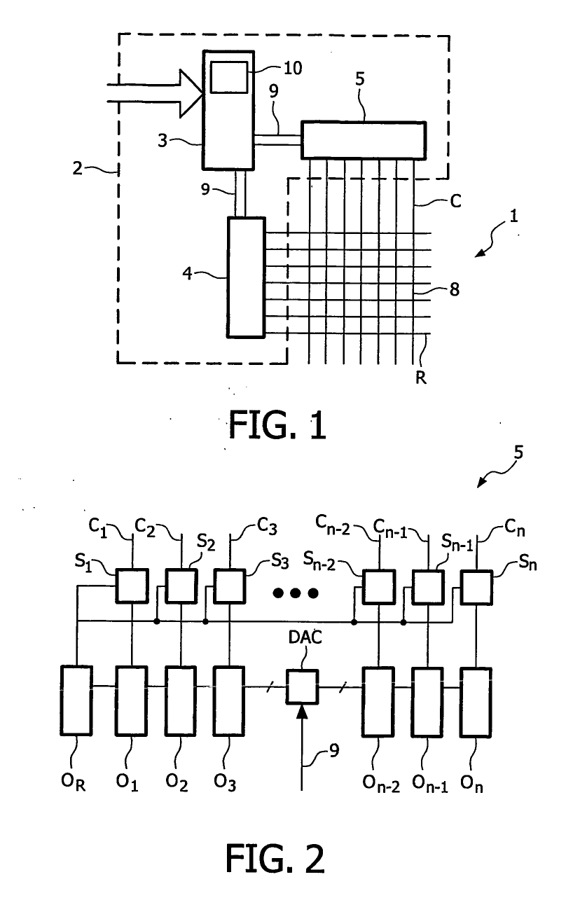

FIG. 1 shows a schematic diagram of a display device;

FIG. 2 shows output channels of the column driver according to the present invention;

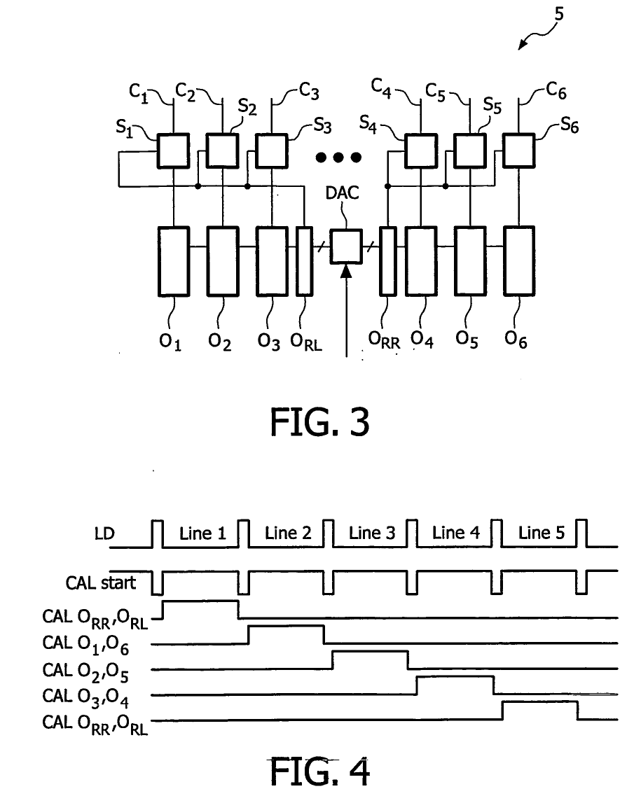

FIG. 3 shows an alternative embodiment of a column driver according to the present invention;

FIG. 4 shows a timing diagram for calibration;

FIG. 1 shows an electric circuit diagram of a display device comprising a display arrangement 1 and a display driver circuit arrangement 2. The display arrangement 1 comprises a matrix of pixels 8 defined by the areas of crossings of row or selection electrodes R and column or data electrodes C. The display driver circuit arrangement 2 includes a row driver 4, which supplies row selection voltages or mutually orthogonal functions to the m row electrodes Rm. Further a column driver 5 is arranged within the display driver circuit, arrangement 2. The column driver 5 supplies column voltage levels according to data to be displayed to the n column electrodes C. To this end, incoming data are first processed, if necessary, in a processor or logic circuitry 3. Mutual synchronization between the row driver 4 and the column driver 5 takes place via control lines 9. The calibration means 10 for performing the calibration in particularly the offset cancellation are arranged within the logic circuitry 3.

FIG. 2 shows a first embodiment of a column driver 5 according to the present invention. The column electrodes are designated with C₁-Cₙ. The column driver 5 includes n output channels O₁-Oₙ, whereas each output channel O₁-On is associated to its column electrode C₁-Cₙ. Further a DAC is illustrated, which converts the digital data into analog data. Between each column electrode C and the associated output channel O a switch S is arranged. The switches S₁-Sₙ are capable to disconnect the output channels O₁-Oₙ from their column electrodes C₁-Cₙ. The additional output channel O_{R} is arranged, whereas the additional output channel O_{R} is also capable to provide a respective column voltage to a column electrode to which it is connected.

The image data will be supplied via the control line 9 to the DA-Converter DAC. The image data for the respective column C, in particular for the pixel in the selected row, which is currently selected, will be provided to the output channel O of this column C. The output channel O comprises a selection matrix for choosing the respective required column voltage, which is supplied to the incorporated output buffer or amplifier, which are not illustrated. The amplified analog signal, which represents the respective column voltage for the pixel is supplied via the switch S to the column electrode C. The additional output channel O_{R} can be switched to each of the column electrodes C₁-Cₙ.

In the case that the additional output channel O_{R} is connected to one of the column electrodes C, e.g. C₂, the image data to be displayed at the selected pixel of this column electrode C₂ is feed to the additional output channel O_{R}. Further the respective output channel O₂ of the column electrode C₂ will be disconnected from this column electrode. During a row selection time the output channel O₂ will be connected to calibration means 10 for offset cancellation. During the next row selection, time the calibrated output channel O₂ is connected to its associated column electrode C₂ to drive this column with the required column voltage in dependency of the image data to be displayed. Simultaneously at this row selection time a further column output channel O, e.g. O₃, will be disconnected from its column electrode C₃ for being connected with the calibration means 10 for calibrating. This column electrode C₃ is driven instead by the additional output channel O_{R}. So after n row selection times all output channels O will be calibrated.

To avoid this probably long time it could be advantageous to use more than one additional output channel O_{R}. Such embodiment is shown in FIG. 3. In general the shown column driver 5 comprises the same components as the column driver shown in FIG. 2. Due to the simplicity only six column electrodes C₁-C₆ are shown, having their switches S₁-S₆ and their output channel channels O₁-O₆. In this embodiment two additional output channels O_{RL} and O_{RR} are included. That means during selection of the first row both additional output channels O_{RL} and O_{RR} will be calibrated. During the second row selection time C₁ and C₆ are driven by the additional output channels O_{RL} and O_{RR} respectively. The output channels O₁ and O₆ are disconnected from their column electrodes for being connected to the calibration means 10. At next the column electrodes C₂ and C₅ are driven by the additional output channels O_{RL} and O_{RR}, whereas the associated output channels O₂ and O₅ will be calibrated. So after four row selection times all 6 column output channels are calibrated.

FIG. 4 shows a calibration timing diagram for the calibration procedure. LD designates the load pulse for loading the data into the column driver so the equivalent column voltages derived from the DAC are applied to the output channels of the driver, which are valid for an entire row selection time. The time between two load pulses LD is the row selection time. Directly after the first load pulse LD the additional output channels O_{RL} and O_{RR} will be calibrated. The calibration stops with the next load pulse LD. At next the output channels O₁ and O₆ are calibrated, then the output channels O₂ and O₅ and output channels O₃ and O₄. After the calibration of all output channels O1-O₆ the procedure starts again with the calibration of the output channels O_{RR} and O_{RL}.

1. Circuit arrangement for driving a display arrangement the circuit arrangement includes column driving means for driving n column electrodes and row driving means for driving m row electrodes of the display arrangement wherein the column driving means comprises n output channels each output channel having a column electrode assigned and is arranged for providing a respective column voltage to the assigned column electrode an additional output channel is arranged for providing respective column voltages, whereas each of the n column electrodes is connectable to the additional output channel.

2. Circuit arrangement as claimed in claim 1, wherein the n output channels having switching means each of the n switching means is provided between an output channel and its associated column electrode for connecting the column electrode with the additional output channel.

3. Circuit arrangement as claimed in claim 2, wherein the switching means are provided for disconnecting the output channel from its column electrode if the column electrode is connected to the additional output channel.

4. Circuit arrangement as claimed in claim 1, wherein at the beginning of driving a first row electrode of a frame the additional output channel is calibrated, whereas during driving the following row electrodes the additional output channel is successively connected via the respective switching means to the column electrodes whereas the associated output channel of the column electrode currently connected to the additional output channel is disconnected from the respective column electrode for calibrating.

5. Circuit arrangement as claimed in claim 1, wherein the column driving means comprises more then one additional output channel which are connectable to the column electrodes.

6. Circuit arrangement as claimed in claim 1, wherein calibration means are arranged for offset cancellation of the output channels connected to the calibration means.

7. Display device comprising a display arrangement and a display driver circuit arrangement the display driver circuit arrangement comprises column driving means for driving the n column electrodes with column voltages and row driving means for driving the m row electrodes with row selection voltages, wherein the column driving means comprises n output channels each output channel having a column electrode assigned and is arranged for providing a respective column voltage to the assigned column electrode, an additional output channel is arranged for providing a column voltage, whereas each of the n column electrodes is connectable to the additional output channel.

8. Display device as claimed in claim 7, wherein the display arrangement comprises a liquid crystal material between a first substrate provided with row electrodes and a second substrate provided with column electrodes in which overlapping parts of the row and column electrodes define pixels.

9. Method for driving a display arrangement whereas the display arrangement comprises n column electrodes and m row electrodes the n column electrodes are driven by column driving means and the row electrodes are driven by row driving means wherein the column driving means comprises n output channels each providing a respective column voltage to its associated column electrode wherein an additional output channel is arranged which is calibrated at the beginning of a driving procedure of a frame, wherein after the additional output channel is calibrated, one of the n output channels is disconnected from its associated column electrode wherein this column electrode is connected to the calibrated additional output channel the calibrated additional output channel supplies the respective column voltage to the column electrode whereas the disconnected output channel is calibrated.
